(19) United States
(12) Patent Application Publication
(10) Pub. No.: US 2006/0271698 A1
(43) Pub. Date: Nov. 30, 2006

(54) BOA BACK OFFICE INTEGRATION PROTOCOL

(76) Inventors: Anthony G. Shrader, Longmont, CO (US); Mahendra Kale, Pune (IN)

Correspondence Address: COCHRAN FREUND & YOUNG LLC, 2026 CARIBOU DR, SUITE 200, FORT COLLINS, CO, 80525, US

(21) Appl. No.: 11/383,676

(22) Filed: May 16, 2006

Related U.S. Application Data
(60) Provisional application No. 60/681,797, filed on May 16, 2005.
(60) Provisional application No. 60/681,781, filed on May 16, 2005.

(51) Int. Cl. G06F 15/16

(52) U.S. Cl. 709/230

(57) ABSTRACT

Disclosed is a back office applications server that provides a single communication interface, or BOA back office integration protocol, for communications between end user applications, such as an agent user interface, and back office applications, such as a database. The communications interface reduces the need for multiple user interfaces using multiple technologies for end user applications connected directly to multiple back office applications, thus reducing the complexity, maintenance, customer interaction time, and upgrade costs for a typical business environment. The back office applications server sends and receives data form pre-existing data systems, converts the pre-existing data system data into a common format, and sends the data to the data consumer using a single, common message format.

### CROSS REFERENCE TO RELATED APPLICATIONS

This application is based upon and claims the priority to U.S. provisional application Ser. No. 60/681,797, entitled “BOA Back Office Integration Protocol” by Anthony G. Shrader and Mahendra Kale filed May 16, 2005, and U.S. provisional application Ser. No. 60/681,781, entitled “User Based—Workflow and Business Process Management” by Anthony G. Shrader and Anthony P. Fox filed May 16, 2005, the entire contents of which are hereby specifically incorporated by reference for all they disclose and teach.

### BACKGROUND OF THE INVENTION

The business workplace is filled with back office systems that assist call center agents in fulfilling their day-to-day tasks. These back office systems traditionally include, databases, mainframes, file servers, email systems, phone system (CTI), etc. These are just a few of the systems that a user may interact with to satisfy the request of their customers, or accomplish a specific business function. Most of these back office systems communicate with a client-based user interface through a series of messages. A client based application can generate a message requesting information and the back office application responds to the request with a message or messages that facilitate the client request. There is usually a separate user interface and business rules system for each separate back office application that makes up the back office system. Thus, multiple user interfaces and business rules implementations are necessary to implement a complex enterprise system made up of multiple back office applications.

### SUMMARY OF THE INVENTION

An embodiment of the present invention may comprise a method for interfacing back office enterprise computer systems to end user computer systems comprising: sending and receiving back office messages to and from at least one back office application, the back office messages formatted according to back office communication protocols, the back office communication protocols being a variety of communication protocols selected according to requirements of the at least one back office application; sending and receiving common language messages to and from at least one data consumer application, the common language messages formatted according to a single common communication protocol; converting the back office messages being delivered to the at least one data consumer application from the back office communication protocols into intermediate compiled object messages for data manipulation prior to finally converting the intermediate compiled object messages into the single common communication protocol for delivery as the common language messages, the intermediate compiled object messages being object data structures written in a standard computer software language and compiled in an associated computer software language compiler application; and converting the common language messages being delivered to the at least one back office application from the single common communication protocol into the intermediate compiled object messages for data manipulation prior to finally converting the intermediate compiled object messages into the back office protocols for delivery as the back office messages.

An embodiment of the present invention may further comprise a back office applications server for interfacing back office enterprise computer systems to end user computer systems comprising: a communications portal that sends and receives back office messages to and from at least one back office application, the back office messages formatted according to back office communication protocols, the back office communication protocols being a variety of communication protocols selected according to requirements of the at least one back office application; a communications portal that sends and receives common language messages to and from at least one data consumer application, the common language messages formatted according to a single common communication protocol; a back office message processing subsystem that converts the back office messages being delivered to the at least one data consumer application from the back office communication protocols into the common language communication protocol for delivery as the common language messages; a common language message processing subsystem that converts the common language messages being delivered to the at least one back office application from the single common communication protocol into the back office communication protocols for delivery as the back office messages; a back office communication component that converts the back office messages into intermediate compiled object messages for data manipulation, the back office communication component also converts the intermediate compiled object messages into back office messages, the compiled object messages being object data structures written in a standard computer software language and compiled in an associated computer software language compiler application; a protocol abstraction layer that converts the intermediate compiled object messages into the common language messages and converts the common language messages into the intermediate compiled object messages; and an object message communication pathway between the back office communication component and the protocol abstraction layer that exchanges the intermediate compiled object messages between the back office communication component and the protocol abstraction layer.

An embodiment of the present invention may further comprise a back office applications server for interfacing back office enterprise computer systems to end user computer systems comprising: means for sending and receiving back office messages to and from at least one back office application, the back office messages formatted according to back office communication protocols; means for sending and receiving common language messages to and from at least one data consumer application, the common language messages formatted according to a single common communication protocol; means for converting the back office messages being delivered to the at least one data consumer application from the back office communication protocols into the single common communication protocol for delivery as the common language messages; and means for converting the common language messages being delivered to the at least one back office application from the single common communication protocol into the back office protocols for delivery as the back office messages.

### BRIEF DESCRIPTION OF THE DRAWINGS

In the drawings,

FIG. 1 is a schematic illustration of the back office applications server system architecture.

FIG. 2 is a schematic illustration of the back office applications server detailed system architecture.

FIG. 3 is schematic illustration of the detailed architecture of the protocol abstraction layer of the back office applications server.

FIG. 4 is a schematic illustration of the back office applications server detailed system architecture showing an example of message delivery from a back office application to a specific data consumer.

FIG. 5 is a schematic illustration of the back office applications server detailed system architecture showing an example of a broadcast message delivery to all data consumers.

FIG. 6 is schematic illustration of the detailed architecture of the protocol abstraction layer with dynamic object creation.

### DETAILED DESCRIPTION OF THE INVENTION

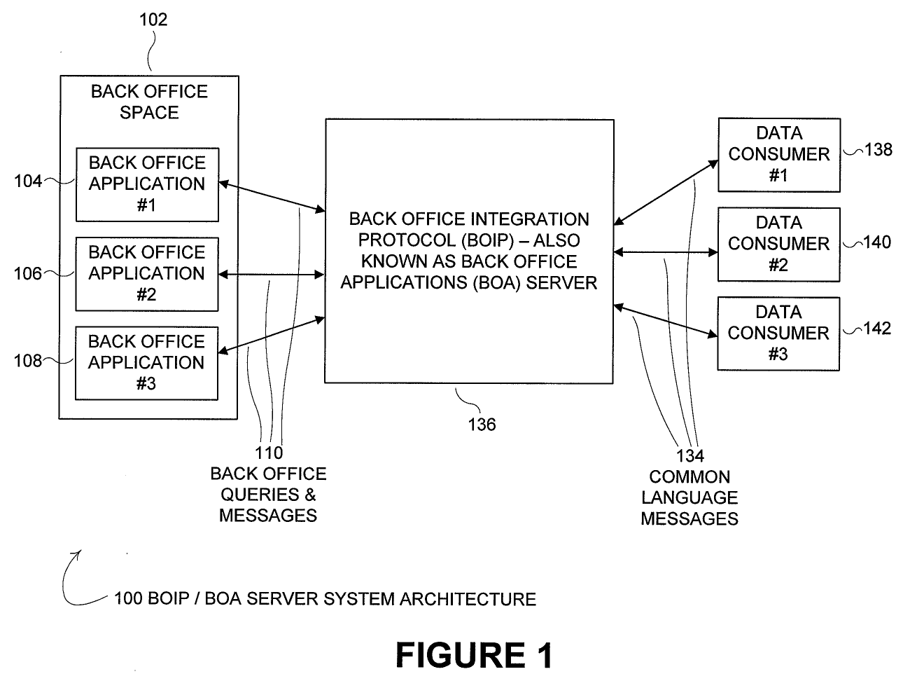

FIG. 1 is a schematic illustration 100 of the back office applications server 136 system architecture. The Back Office Applications (BOA) server 136 is also called the Back Office Integration Protocol (BOIP) 136. Further description of an application of the BOA Server 136 is disclosed in the previously mentioned patent application Ser. No. 60/681,781, entitled “User Based—Workflow and Business Process Management.” The following is a list of acronym definitions that are helpful when discussing the BOA server 136.

CTI—Computer Telephony Integration. CTI involves integrating a traditional voice system to a data system, specifically “Screen Pop” or “PC based Soft Phone”.

BOA Server—Back Office Applications Server, also know as Back Office Integration Protocol (BOIP).

BOIP—Back Office Integration Protocol, also known as BOA Back Office Integration Protocol and BOA Server.

DOC—Dynamic Object Creation.

PAL—Protocol Abstraction Layer.

POJO—Plain Old Java Objects.

AUI—Administrative User Interface.

OTCC—Object To Common language message format Conversion.

CTOC—Common language message format To Object Conversion

OCI—Object Collection Interface.

BOCC—Back Office Communication Component.

UI—User Interface.

XML—eXtensible Markup Language.

The back office space 102 is made up of multiple back office applications 104, 106, 108. The back office applications 102, 104, 106 may use different communications technologies to send and receive back office queries and messages 110. The BOA server 136, also known as BOA back office integration protocol 136, acts as a single interface for handling all back office communications 110 necessary to operate an end user data consumer 138, 140, 142. The BOA server 136 converts the multiple communications formats of the back office space 102 into a single communication format, called common language message format, and sends/receives the Common Language Messages (CLM) 134 to/from the data consumers 138, 140, 142. A text based standard language, such as XML, is a good beginning point when defining the common language message format. A typical end user data consumer 138, 140, 142 is a user interface for a person working as a call center agent, but the data consumer 138, 140, 142 may be any application that requires interaction with the back office space 102. Information on the XML specification and many other Internet protocols is kept and developed by the W3C: World Wide Web Consortium. The W3C: World Wide Web Consortium may be contacted in care of MIT at 32 Vassar Street, Room 32-G515, Cambridge, Mass. 02139, USA, telephone number 617-253-2613, and web site www.w3c.org.

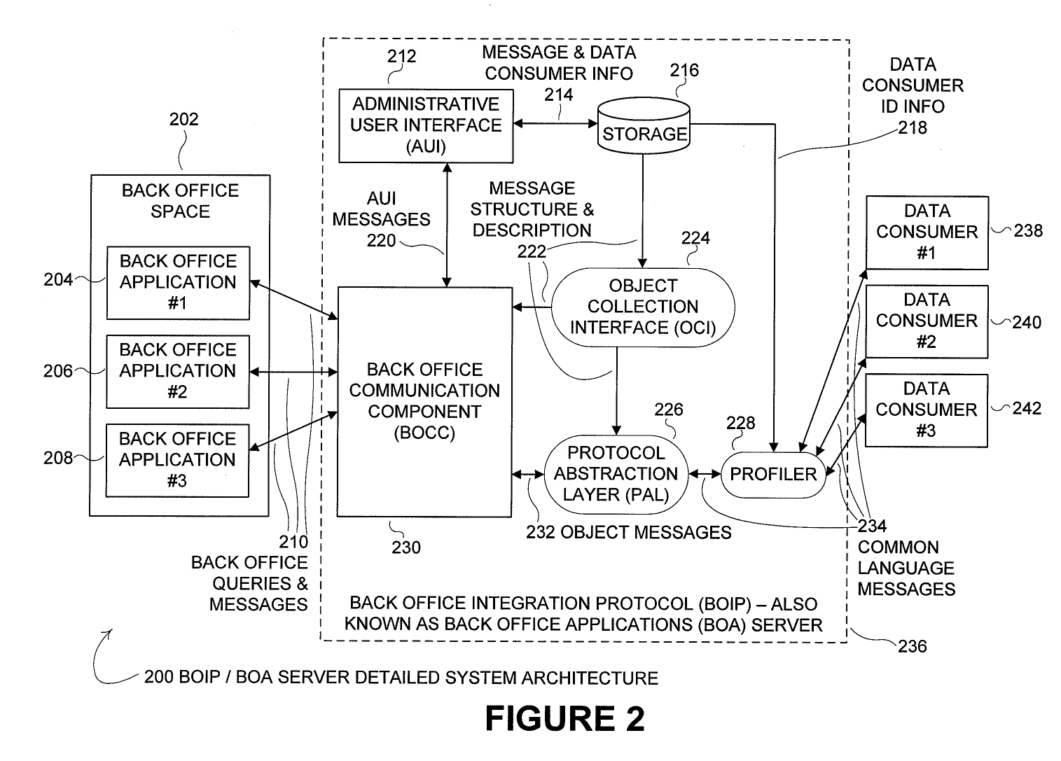

FIG. 2 is a schematic illustration 200 of the back office applications server 236 detailed system architecture. The BOA server 236, also known as BOA back office integration protocol, is composed of three subsystems, the Protocol Abstraction Layer (PAL) 226, the Back Office Communication Component (BOCC) 230, and the Object Collection Interface (OCI) 224. The back office communication component 230 is responsible for communicating 210 with the back office applications 204, 206, 208 in the native communication format of the back office applications 204, 206, 208 contained in the back office space 202. The protocol abstraction layer 226 is responsible for converting common language messages 234 to and from object messages 232 for communication with the back office communication component 230. The protocol abstraction layer 226 is composed of two components which covert the common language messages 234 to object messages 232 and the object messages 232 to common message language messages 234. The protocol abstraction layer 226 sends/receives object messages 232 to/from the back office communication component 230. The back office communication component 230 converts object messages 232 to/from the specific back office queries and messages 210 required to communicate with the back office space 202.

The back office communication component 230 takes data passed in object messages 232 and converts the data into query and message 210 formats acceptable to the back office applications 204, 206, 208. The back office communication component 230 also converts the back office specific queries and messages 210, and converts the queries and messages 210 into object messages 232 which are passed to the protocol abstraction layer 226. As a result, the back office communication component 230 is freed from converting common language messages 234 directly to back office acceptable queries and messages 210 or from converting back office queries and messages 210 to common language messages 234. The BOA server 236 provides an layer for administrative and other processing, such as identifying and forwarding object messages 232 to the appropriate back office application 204, 206, 208, converting one object message 232 to multiple common language messages 234 of different formats depending upon the data in the object message 232. The data in the object message 232 may be tested for certain business environment conditions, for example, if the data in the object message 232 contains the demographic information for a customer, and if the customer data contains a state (i.e., CO, AZ, MN, etc) code, the format of the common language message 234 may be changed to different formats dependant on the state code value.

The protocol abstraction layer exchanging object messages 232 (object structures in an object oriented language) with the back office communication component 230 provides the flexibility of having run time access to data and the inherent speed and efficiency of accessing object data structures when communicating 210 directly with the back office applications 204, 206, 208. Speed and efficiency are especially important when dealing with the back office applications 204, 206, 208 because the back office communication protocols 210 can vary according to bits, bytes, special tag based values, fixed data length, delimited messages, simple request and response based messages, complex inter embedded data object messages, and so forth. The data in a common language message 234 can be more efficiently converted to back office queries and messages 210 once the data is made available at runtime via conversion of the common language message 234 to an object message 232. By using the object message 232 rather than attempting to convert the text of the common language message 234 directly into the back office queries and messages 210 the interaction with the back office space 202 avoids the need to directly convert text to specific data types, a process which can be repetitive and time consuming.

The object collection interface subsystem 224 acts as an interface to a collection of object message 232 and common language message 234 formats. The back office communication component 230 and the protocol abstraction layer 226 obtain message structures and descriptions 222 from the object collection interface 224. The object collection interface 224 is available for other external systems that may need access to the message structure and description 222 of object message 232 or common language message 234 formats. The object collection interface 224 may be queried to obtain a message and the properties associated with the message 222, or the object collection interface 224 may provide a message description 222 for a customized message. The ability to query the object collection interface 224 provides the ability for a data consumer 238, 240, 242 to “ask” the object collection interface 224 for the message formats and functions that are available in the back office applications 204, 206, 208 and then determine correct common language message 234 format for future communications with the back office space 202.

The object collection interface 224 obtains the message structure and description 222 from values contained in a non-volatile storage medium 216. Both the back office communication component 230 and the protocol abstraction layer 226 query the object collection interface 224 to obtain object message and description of object message elements 222 needed to create a common language message format based message 234.

The message structure and description configuration is performed by an administrator using the administrative user interface 212. The administrative user interface stores the message configuration information 214 in the storage medium 216. The administrative user interface 212 also permits the administer to configure data consumer information 214 and store the data consumer information 214 in the storage medium 216 for later use by the profiler component 228. Further, the administrative user interface 212 may send/receive administrative messages 220 to/from the back office communication component 230 as well as other components of the BOA server 236.

A profiler component 228 may assist the protocol abstraction layer 226 in identifying the data consumer 238, 240, 242 for a common language message 234. The profiler 228 is not a required piece of the BOA server system 236. The profiler 228 reads the common language message 234 and identifies the associated data consumer(s) 238, 240, 242 using data consumer identification information 218 obtained from the storage medium 216. The administrative user interface 212 is used to configure the data consumer information 214 and to store the information in the storage medium 216.

Generally, the BOA server works in following manner:
b 1. the data consumer 238, 240, 242 posts a text based request for data retrieval 234 which is then converted to an object 232 by the protocol abstraction layer 226;
2. the object 232 is then converted to back office specific protocols 210 and forwarded to the back office space 202 by the back office communication component 230;
3. any response data 210 from the back office space is converted to an object 232 by the back office communication component 230; and
4. the object 232 is converted to a common language message 234 and forwarded to data consumers 238, 240, 242 by the protocol abstraction layer 226.

The BOA server 236 works in both synchronous and asynchronous communication modes. For the synchronous communication mode, the data consumer 238, 240, 242 sends a common language message 234 request and the BOA server responds by replying with data from the back office space 202 contained in common language messages 234. For the asynchronous communication mode, the BOA server 236 posts a common language message 234 to the data consumer(s) 238, 240, 242 as part of an event on the back office space 202 or as the result of a data consumer 238, 240, 242 request issued to an asynchronous back office application 204, 206, 208. The ability to handle synchronous and asynchronous communication modes provides maximum flexibility to the data consumer 238, 240, 242 and the data provider 204, 206, 208 as messages 234 are delivered to a data consumer 238, 240, 242 based on the profile of the data consumer, not based strictly on a data request.

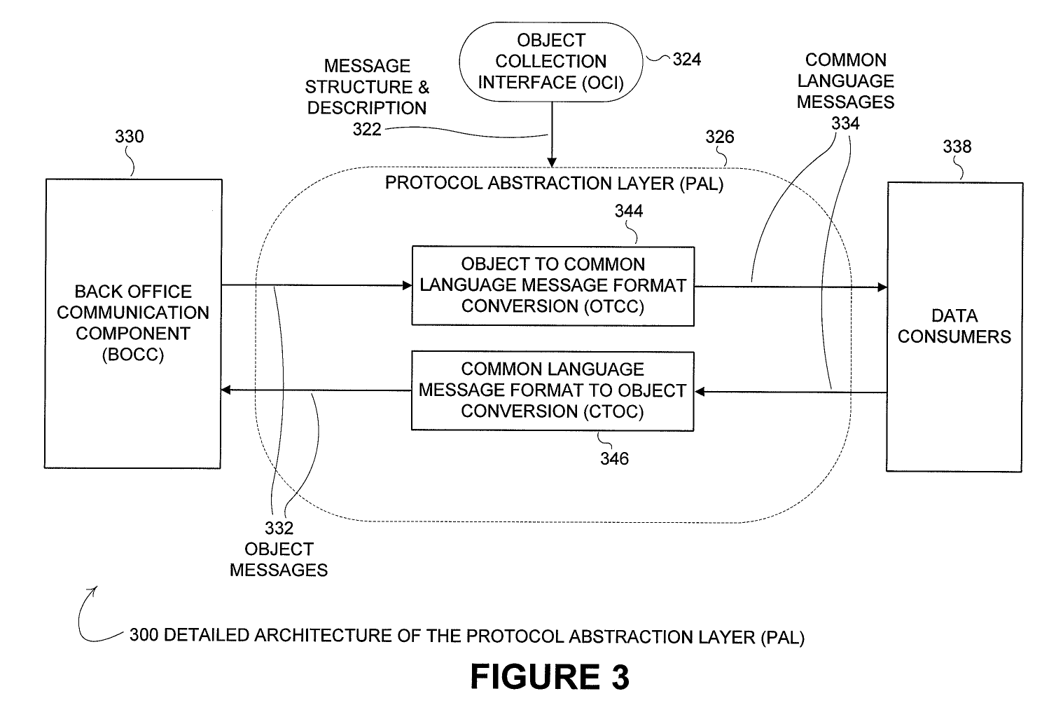

FIG. 3 is schematic illustration 300 of the detailed architecture of the protocol abstraction layer 326 of the back office applications server. The protocol abstraction layer system 326 is composed of two subsystems. One subsystem is for Common language message format To Object Conversion (CTOC) 346. The second subsystem is for Object To Common language message format Conversion (OTCC) 344. The CTOC 346 and OTCC 344 work independently of each other. A complete message flow through the protocol abstraction layer 326 contains the following steps:
1. the data consumer 338 sends a common language message 334 ‘data extraction request’ to the protocol abstraction layer 326;
2. the protocol abstraction layer 326 identifies the direction and type of common language message 324 and selects a particular object message 332 to fill in with the common language message 334 data and calls the CTOC 346 to convert the common language message 334 into an object message 332 and passes the object message to the back office communication component 330;
3. c). the BOA back office integration protocol, also known as the BOA server, identifies the object message 332 association to the back office space and instructs the back office communication component to send the data in the object message 332 to the particular back office application identified;
4. the back office communication component 330 converts the object message 332 to back office specific message protocols such as a byte message, HTTP request or web service request and sends the back office message to the identified back office application;
5. the back office application sends a response in back office specific format to the back office communication component 330 which converts the back office specific response to an object message 332, and passes object message 332 to the protocol abstraction layer 326;
6. the protocol abstraction layer 326 identifies the direction and type of the object message 332 and calls the OTCC 344 to convert the object message into a common language message 334;

The OTCC 344 also uses user defined tags for common language message 334 formatting by querying the object collection interface 324 with the common language message 334 identifier and the back office identifier. The object collection interface 324 reads storage to retrieve message structure and description information 322 defined using the administrative user interface. The object collection interface delivers the message structure and description information 322 to the protocol abstraction layer 326. In order for the CTOC 346 to function, the object 332 must be registered with common language messages using the administrative user interface. Each incoming common language message, such as the request described above, is given a unique number called a category code. Specific object messages should be registered with each of common language message type. In order for the OTCC 344 to allow conversion of each element of the object message 332 into common language message format, each element must be defined in the administrative user interface. In case the description of the object message 332 is not present in configuration of the object collection interface 324, each object message 332 element is converted to a common language message format element by putting the element name as the tag and the element value as the tag value. All objects must be coded and compiled error free in accordance to the rules specified by the protocol abstraction layer 326. An object may be implemented using Plain Old Java Objects (POJO). The protocol abstraction layer rules are:
1. each object message 332 should have methods which return the unique ID of object message, called the category code;
2. each object message 332 should have a method which returns the type of object the object message 332, such as, 1 for a request object and 2 for a response object;
3. all data elements in an object message 332 should be declared public so that other software modules may access the data elements directly;
4. all incoming common language messages 334 must have a category code message descriptor field and associated value which uniquely identify the message and function code, such as a value of 1 which represents a request message type.

The common language message format to object conversion process begins by breaking up the common language message 334. When the protocol abstraction layer 326 receives a common language message 334, the protocol abstraction layer 326 extracts all elements and values in the common language message 334 and stores the data in memory. An embodiment of the invention 300 may store the data in any format that provides data storage in memory, and allows for searching and manipulation of the data in memory. Storing the data in name and value pairs, database rows, or files are examples of the different possible data storage methods. The embodiment of the invention 300 shown in FIG. 3 implements data storage using name and value pairs, but any data storage method would be acceptable. Once the common language message 334 is broken into name and value pairs, the protocol abstraction layer 326 references the common language message 334 configuration with an object message by identifying field values, such as the category and function code, through the object collection interface 324. As an example, the category and function code has a value of 1 for request, a value of 2 for response, and a value of 3 for asynchronous events. Once the object name is found, the protocol abstraction layer 326 creates a new instance of the object and gets the object ready to fill with data in the CTOC module 346. The CTOC 346 conversion process takes the object name and value pair and starts filling the object using the following procedural steps:
1. the CTOC 346 obtains the first element of the name and value pair;
   2. the CTOC 346 then searches the object for an element which is identical to the name in the name and value list;
3. if the element is found the CTOC 346 performs one of the following steps and then advances to the next name and value pair in the list and returns to step 2:
   a. if the name is an array of other elements then the CTOC 346 creates an array object and start filling the array object with values from the name and values list;
   b. if the name matches the object name exactly then the CTOC 346 recursively enters the same CTOC 346 module in order to fill the object and return once the object is completely filled with data;
   c. if the name is of an array of objects, then for each object in the name value the CTOC 346 fills each single element in the object with value of the name and value pair;
   d. if the name is a single element in an object the CTOC 346 places the value of the name and value pair into the object element; and
4. if no object element is found with the given name then the CTOC 346 drops that element from the form and fills in the object, then advances to the next element in the name and value list and returns to step 2. Another option is that the protocol abstraction layer 326 holds onto the unfilled elements and evaluates those elements when the response 332 from the back office application is received by the OTCC 344, thus, the unfilled elements may be used by the profiler to add user profile information into the common language message 334. By keeping the information in the unfilled elements, the profiler is able to identify the specific data consumer 338 for the response 332 from the back office application. Keeping the unfilled elements is particularly useful for synchronous systems.

Once the object is filled with the data from the common language message 334 the object is then given to BOA server for further processing such as identifying the back office communication module which should handle/process the request. The back office communication module 330 receives the object 332 and identifies how to translate the object message 332 to back office protocols using the object message 332 category code.

The advantages of the protocol abstraction layer 326 providing the object 332 to and from the back office communication module 330 are:
1. data from the common language message 334 message ,which is mostly text based, is converted to specific data types such as integer, alphanumeric, numeric, array of data types, and array of objects;
2. the back office communication component 330 module is freed from data type conversion and may extract data from the object 332 which the back office communication component 330 knows of in advance according to the common language message 334 request type, and the back office communication component 330 may also compose a back office request which is more back office protocol specific;
3. conversion from object 332 data is faster and easier to access than any other form of data storage including bytes, text, and the others;
4. conversion from object 332 data to any other data type is faster and more efficient; and
5. conversion from object 332 data to a text based message neutralizes any platform specific data characteristics such as order of numeric data in memory, precision, sign handling, length, and length limitation.

To help understand the CTOC 346, it is helpful to look at an example of the operation. The example assumes that a database based back office application is configured in the system and the back office application requires a request to extract customer transaction data. The request includes customer details such as name, address, phone number, and the like. The example also assumes that both the request and the response objects required for the example process are created and registered with the object collection interface 324. The example uses JAVA programming language syntax to describe the object, and XML is used as common language message 334 format. In the JAVA programming language the rules may be composed as an interface. If an object 332 implements any particular interface, then the object 332 has to implement all methods of the interface and return the response as transaction details.

The data consumer 338 sends the data extraction request 334 in the following format:

Example Request Message (334):

```
<Message>
    <Category>1000</ Category >
    <Function>1</Function>
    <Body>
        <CustomerName>James BOB</ CustomerName>
        <Address1>15 TH ST, BLK 1580</Address1>
        <City>Longmont</City>
        <PhoneNumber>1234567890</PhoneNumber>
    </Body>
</Message>
Public Interface Protocol Abstraction Layer (326) Rules:
{
    public int getCategoryCode( );
    public int getFunctionCode( );
    public String getObjectName( );
    public void printObject( );
};
```

Example Object (332):

```
Class CustomerDetails implements PALRules
{
    public int Category = 1000;
    public int Function = 1;
    public String CustomerName = null;
    public String Address1 = null;
    public String City = null;
    public String PhoneNumber = null;
    public int getCategoryCode( )
    {
        return Category;
    }
    public int getFunctionCode( )
    {
        return Function;
    }
    public String getObjectName( )
    {
        return “CustomerDetails”;
    }
    public void printObject( )
    {
        System.out.println(“Category:”+ Category);
        System.out.println(“Function:”+ Function);
        System.out.println(“Customer Name:”+ CustomerName);
        System.out.println(“Address:”+ Address1);
        System.out.println(“City:”+ City);
        System.out.println(“PhoneNumber:”+ PhoneNumber);
    }
};
```

Example Message (334) Break Up:

In the message (334) break up process, the CTOC (346) process creates a name and value table from the request message (334) in memory as follows:

| Name | Value |
|---|---|
| CustomerName | James BOB |
| Address1 | Th ST, BLK 1580 |
| City | Longmont |
| Phone Number | 1234567890 |

In the next step the CTOC (346) module obtains the category and function values and searches the object collection interface (324) to find an object registered with the same category code and function code as the common language message (334). In the present example the object will be a CustomerDetails object.

Once the CTOC (346) finds the object, the CTOC (346) creates a new instance of the object. At the present step, if the CTOC (346) invokes the printObject( ) method of the object, the CTOC (346) will generate the following output object that is not yet filled with data. Only the object elements which are initiated with the value are printed correctly in the present example.

Category: 1000

Function: 1

Customer Name: null

Address: null

City: null

PhoneNumber: null

After the object is created, the CTOC (346) module follows the conversion process steps, described as follows:
1. the CTOC (346) obtains the first element of the name and value pair, in the present case CustomerName;
2. the CTOC (346) then searches the object for an element which is identical to the name in the name and value list;
3. if the element is found the CTOC (346) performs one of the following steps and then advances to the next name and value pair in the list and returns to step 2, in the present case the process jumps to step ‘d’ and advances to the next name and value pair in the table of Address1;
   a. if the name is an array of other elements then the CTOC (346) creates an array object and start filling the array object with values from the name and values list, skipped in the present case;
   b. if the name matches the object name exactly then the CTOC (346) recursively enters the same CTOC (346) module in order to fill the object and return once the object is completely filled with data, skipped in the present case;
   c. if the name is of an array of objects, then for each object in the name value the CTOC (346) fills each single element in the object with value of the name and value pair, skipped in the present case;
   d. if the name is a single element in an object the CTOC (346) places the value of the name and value pair into the object element, the CTOC (346) fills the value in the CustomerName element of the object with ‘James BOB’; and
4. if no object element is found with the given name then the CTOC 346 drops that element from the form and fills in the object, then advances to the next element in the name and value list and returns to step 2.

The above steps are performed until all object elements are filled with the associated values contained in the common language message (334). At the present stage, if the CTOC (346) module invoked the printObject( ) method of the object, the CTOC (346) will generate the following output:

Category: 1000

Function: 1

Customer Name: James BOB

Address: TH ST, BLK 1580

City: Longmont

PhoneNumber: 1234567890

The common language message format to object conversion process begins with by breaking up the common language message 334. When the protocol abstraction layer 326 receives a common language message 334, the protocol abstraction layer 326 extracts all elements and values in the common language message 334 and stores the data in memory in name and value pairs. Once the common language message 234 is broken into name and value pairs, the protocol abstraction layer 326 references the common language message 334 configuration with an object message by identifying field values, such as the category and function code, through the object collection interface 324. As an example, the category and function code has a value of 1 for request and a value of 2 for response or asynchronous events. Once the object name is found, the protocol abstraction layer 326 creates a new instance of the object and gets the object ready to fill with data in the CTOC module 346. The CTOC 346 conversion process takes the object name and value pair and starts filling the object using the following procedural steps:

Once the back office communication module 330 sends a request to the back office space in the native back office application communication format, the back office application responds with a response message carrying response data, thus, starting the object to common language message format conversion process 344. The back office communication component 330 converts data from the native back office application format into an object message 332. The back office communication component 330 selects a registered object for a response message from the object collection interface 324 and fills the object with the response data of the back office response message. The back office communication component 330 is responsible for identifying the proper response object 332 and filling the response object 332 with the back office response data. The back office response data is then posted to the requesting data consumer 338 using a common language message 334 filled with the back office response data by the OTCC module 344. A back office application may generate an event message without a corresponding request from the data consumer 338, hence, it is not required that the back office message handled by the OTCC 344 be a response to a message initiated by a data consumer 338.

The OTCC process 344 begins when the OTCC 344 receives an object 332. The OTCC 344 then queries the object 322 for identifying elements such as category code and function code. Based on the category code and function code the OTCC 344 queries the object collection interface 324 to find out how to convert the object 322 to a common language message 334. In contrast to the CTOC process 346, which is a “one-to-one” association between a common language message 334 and elements of an object 332, the OTCC process may create one or many common language messages 334 from a single object message 332. The one to many ability of the OTCC 344 means that an administrator may provide a different tag name for inclusion in an OTCC 344 output common language message 334 rather than just the names of elements for a single object message 332. The OTCC 344 may break one object 332 into multiple elements, each with a different tag. There are two possible scenarios for when the OTCC 344 may need to handle a one to many conversion. The first scenario occurs when information on how to break up or decompose object 332 elements into common language message 334 elements is not present. The second scenario occurs when information on how to break up or decompose object 332 elements into a common language message 334 message elements is present.

For the first scenario the OTCC 344 process simply obtains the object element name and converts the object element to the common language message format tag. The OTCC 344 also obtains the value of the named object element and fills the value in as the value of the named output common language message element.

For the first scenario the OTCC (344) conversion process performs the following steps:
1. create a common language message document for writing back office message data;
2. query the object (322) for the first element of the object (322);
3. extract the element name and value from the object (322);
4. put the element name as a common language message format message tag into the common language message document;
5. put the object (322) element value into the common language message format document as a common language message format tag value;
6. query the next element of the object (322), if the next element is present then return to step 3; and
7. close the common language message format document and pass the common language message format document as a common language message (334) to a data consumer (338).

For the second scenario the OTCC (344) conversion process performs the following steps:
1. create a common language message format document for writing back office message data;
2. query the object (322) for the first element of the object (322);
3. extract the element name and value from the object (322), check the configuration in the object collection interface (324) to find out if the object element needs to be further broken up, if the object element does need to be broken up further, perform the following steps, otherwise put the object element name into the common language message format document as a tag and put the object element value into the common language message format document as a tag value;
   a. find out how to break up the object element based on the object element delimiter or size;
   b. break up the object element value and find the specific tag name to put the object element value in;
      c. put the break up value into the name and value pair associated with the configured tag name of common language message format document;
      d. repeat steps ‘b’ and ‘c’ until the break up process of the object message (332) is complete;
4. query the next object element and if the next object element is resent then return to step ‘3’;
5. close the common language message format document and pass the common language message format document as a common language message (334) to a data consumer (338).

Example Response Object:

When the back office communication component (330) receives a response from the back office space, the back office communication component (330) extracts all of the data elements from the back office response message and fills in the object before the back office communication component (330) passes the object (332) to the OTCC module (344).

```
public class TransactionDetails implements PALRules
{
  public int Category = 1001;
  public int Function = 2;
  public String TransactionDate=”01/02/2004”;
  public float TransactionAmount=100.0;
  public int NumberOfItems = 1;
  public String TransactionType = “Card”;
  public String CardType = “Credit Card”;
  public int getCategoryCode( )
  {
    return Category;
  }
  public int getFunctionCode( )
  {
    return Function;
  }
  public String getObjectName( )
  {
    return “CustomerDetails”;
  }
  public void printObject( )
  {
    System.out.println(“Category:”+ Category);
    System.out.println(“Function:”+ Function);
    System.out.println(“Transaction Date:”+ TransactionDate);
    System.out.println(“Transaction Amount:”+ TransactionAmount);
    System.out.println(“Number Of Items:”+ NumberOfItems);
    System.out.println(“Transaction Type:”+ TransactionType);
    System.out.println(“Card Type:”+ CardType);
  }
}
```

If the OTCC module (344) invoked the printObject( ) method of the PALRules interface of the object, the OTCC (344) will generate the following output:

Category1001

Function: 2

Transaction Date: 01/02/2004

Transaction Amount: 100.0

Number of Items: 1

Transaction Type: Card

Card Type: Credit Card

At the present stage the OTCC module (344) calls the PALRules method on the object to retrieve the object category code and function code, and the OTCC (344) searches the object collection interface (324) for possible object elements to place in the common language message (334).

As described previously there are two possible scenarios when dealing with in the search of the object collection interface (324) as follows:
1. the object description is not present in the object collection interface (324); or
2. the object description is present in the object collection interface (324).

The following describes an example of the first scenario. In the present example, the OTCC module (344) follows the conversion process for the first scenario, described as follows:
1. create a common language message document for writing back office message data, for the present example an empty document is created (<Message>);
2. query the object (322) for the first element of the object (322), in the present example the first element is Category;
3. extract the element name and value from the object (322), in the present example the name of the element is Category and the value is 1001;
4. put the element name as a common language message format message tag into the common language message document, in the present example the <Category> tag is created;
5. put the object (322) element value into the common language message format document as a common language message format tag value, in the present example the <Category>1001</Category> tag value is created;
6. query the next element of the object (322), if the next element is present then return to step 3, in the present example the next element is Function; and
7. close the common language message format document and pass the common language message format document as a common language message (334) to a data consumer (338).

Once the CardType element is placed into the response output common language message (334), the OTCC module (344) closes the response common language message document. The response common language message document is as follows:

Example Message Response:

```
<Message>
    <Category>1001</Category>
    <Function>2</Function>
    <Body>
        <TransactionDate>01/02/2004</TransactionDate>
        <TransactionAmount>100.0</TransactionAmount>
        <NumberOfItems>1</NumberOfItems>
        <TransactionType>Card</TransactionType>
        <CardType>Credit Card</CardType>
    </Body>
</Message>
```

The following describes an example of the first scenario. In the present example the OTCC module (344) follows the conversion process for the first scenario. The break down of the object (332) into a common language message (334) may be customized by providing different tag names in the object collection interface (324) and/or breaking one object element value into multiple values and providing different tag name to the broken up elements. If a back office application sends transaction details in one long stream of character delimited data with a ‘|’ as the character delimiter, then the response object will appear as follows:

```
public class TransactionDetails implements PALRules
{
    public int Category = 1001;
    public int Function = 2;
    public String TransactionDetails=”01/02/2004|100.0|1|Card|Credit
    Card”;
    public int getCategoryCode( )
    {
        return Category;
    }
    public int getFunctionCode( )
    {
        return Function;
    }
    public String getObjectName( )
    {
        return “CustomerDetails”;
    }
    public void printObject( )
    {
        System.out.println(“Category:”+ Category);
        System.out.println(“Function:”+ Function);
        System.out.println(“Transaction Details:”+ TransactionDetails);
    }
}
```

If the OTCC module (344) invoked the printObject( ) method of the PALRules interface of the object, the OTCC (344) will generate the following output:

Categoryl 001

Function: 2

Transaction Details: 01/02/2004|100.0|1|Card|Credit Card

It is difficult to interpret the output data above. In the present example, a special break up of the object may be configured and provided to OTCC module (344) from the object collection interface (324). The break up of the object may appear as defined in the following tables. The configuration may be stored with a category code and a function code in the object collection interface (324) so that the OTCC module (344) is able to find and use object break up definition. Registration of the request/response object with category code, function code and custom tag name may be performed using the administrative user interface which stores the configuration information in non-volatile storage. The configuration information may be queried using the object collection interface (324).

| | | | | | # |
|---|---|---|---|---|---|
| | | | | | Ele- |
| Element Name | Delimited? | SizeFixed? | Delim | Size | ments |
| TransactionDetails | true | false | \| | 0 | 5 |

| Element Name | Sub Element Number | XML |
|---|---|---|
| TransactionDetails | 1 | <TransactionDate> |
| TransactionDetails | 2 | <TransactionAmount> |
| TransactionDetails | 3 | <NumberOfItems> |
| TransactionDetails | 4 | <TransactionType> |
| TransactionDetails | 5 | <CardType> |

In the present example, the OTCC module (344) knows in advance that the particular object element is composed of 5 different data elements separated by the special character ‘|’. When the OTCC module (344) breaks the TransactionDetails element of the object into five different elements, the OTCC (344) uses a custom tag for each of the values broken out of the TransactionDetails element and puts the value into the response common language message document.

The following describes an example of the second scenario. In the present example the OTCC module (344) follows the conversion process for the second scenario, described as follows:
1. create a common language message format document for writing back office message data, in the present example an empty common language message format document is created and the <Message> and the following elements will be created as in the example for the first scenario;
2. query the object (322) for the first element of the object (322), in the present example the element of interest is the TransactionDetails element;
3. extract the element name and value from the object (322), check the configuration in the object collection interface (324) to find out if the object element needs to be further broken up, if the object element does need to be broken up further, perform the following steps, otherwise put the object element name into the common language message format document as a tag and put the object element value into the common language message format document as a tag value, in the present example the TransactionDetails element is composed of five different elements and will need to be broken up further;
   a. find out how to break up the object element based on the object element delimiter or size, in the present example the data is broken up by the ‘|’ character delimiter;
   b. break up the object element value and find the specific tag name to put the object element value in, in the present example the first value broken out is 01/02/2004;
   c. put the break up value into the name and value pair associated with the configured tag name of common language message format document, for the present example the first element tag configured is <TransactionDate> and output is <TransactionDate>01/02/2004</TransactionDate>;
   d. repeat steps ‘b’ and ‘c’ until the break up process of the object message (332) is complete;
4. query the next object element and if the next object element is resent then return to step ‘3’, for the present example step 4 is skipped;
5. close the common language message format document and pass the common language message format document as a common language message (334) to a data consumer (338).

The BOA server as a whole and the back office communication component (330) work in synchronous and asynchronous communication modes. When the back office applications are registered with the object collection interface (324), the user may also specify the communication model for back office applications as synchronous or asynchronous. For either communication model, any back office application may trigger an event message which may be converted to a common language message (334) and posted to a data consumer (338). The BOA server also allows the user to define a message dispatch mode. The protocol abstraction layer (326) works as an independent module and provides the functionality of converting an object (332) into a common language message (344) and converting a common language message (334) into an object (33). The design of the protocol abstraction layer (326) allows the BOA server to use the protocol abstraction layer independently of the back office communication model. Note that unsolicited triggered messages from the back office space are called events.

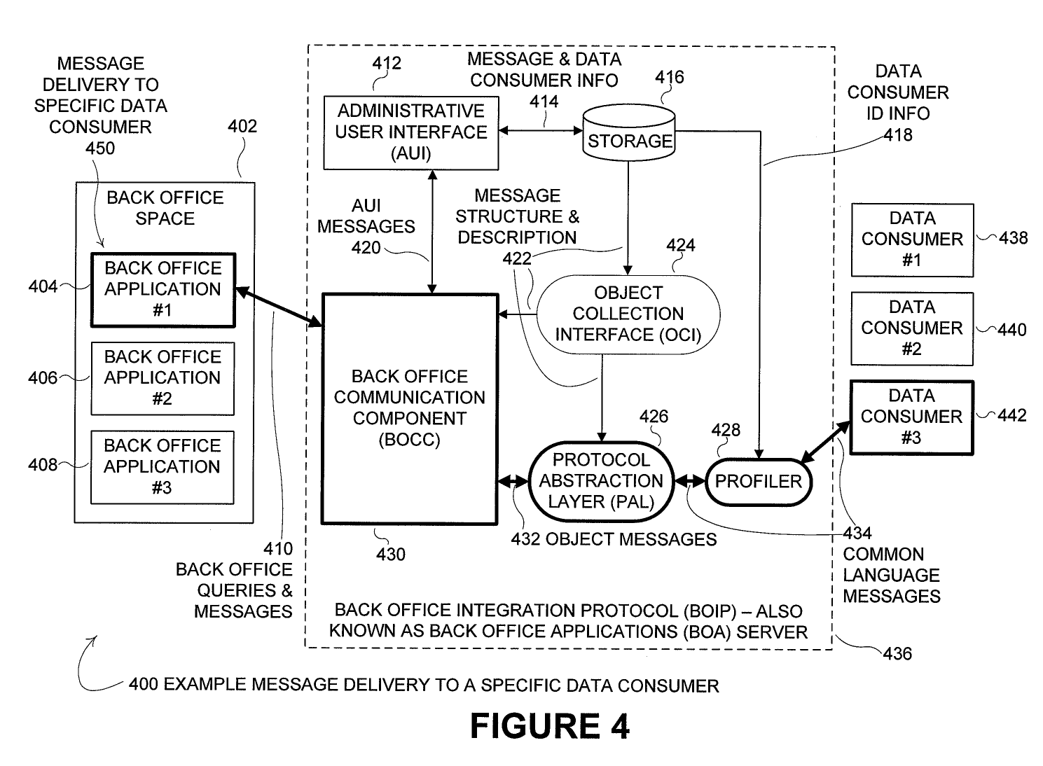

FIG. 4 is a schematic illustration 400 of the back office applications server 436 detailed system architecture showing an example of message delivery 450 from a back office application 404 to a specific data consumer 442. To better facilitate message delivery an additional module, called the profiler 428, may be employed to handle and be responsible for maintaining data consumer 438, 440, 442 identity and delivering common language messages 434 to the correct data consumer 438, 440, 442. The profiler 428 determines the correct data consumer 438, 440, 442 to send a common language message 434 by examining the identifying fields contained in the common language message 434. In embodiment of the BOA server system 436, a data consumer account is created for each data consumer 438, 440, 442 with a unique “profile” login id and password. The “profile” data consumer account contains fields that match fields for a particular common language message 434.

In the case of a CTI back office application 404, 406, 408, for example, a data consumer 438, 440, 442 phone extension and location are part of the “profile.” When events are generated in a specific CTI back office application, here back office application #1 (404), the event messages 410 are received by the back office communication component 430, converted to object messages 432, and then sent to the protocol abstraction layer 426. The protocol abstraction layer 426 converts the object message 432 into a common language message 434 as described in the disclosure with respect to FIGS. 2 and 3. The common language message 434 is then forwarded to the profiler 428 where the common language message 434 is scanned to extract the identifying fields which are part of the data consumer 438, 440, 442 “profiles.” The data values in the identifying fields help the profiler 428 to identify the proper data consumer, here data consumer #3 (442), and then post the event common language message 434 to the specific data consumer 442 without the need for a previous request to have been posted by the specific data consumer 442.

Example Profile:
Login ID: Bob1234
Password: Smith
Name: Bob Smith
Location Code: 5000 (Denver)
Extension: 77885
Email ID: bob smith@ecc.com
Main Frame ID: data1234
Web Service Token: 123-ABXY-CH-7790-RTQ

The example “profile” above contains Extension, Location Code, Email ID, Main Frame ID, and Web Service Token fields and associated data. The fields in the profile become fields which are subsequently placed in various common language messages 434 for the communications from various back office applications 404, 406, 408. When the data contained in a common language message 434 matches the data contained in a data consumer 438, 440, 442 profile, the profiler 428 directs the common language message 434 to the specific matching data consumer 442.

The profiler 428 has unique dispatching capabilities because the profiler permits data consumers 438, 440, 442 to have matching “profile” data. When multiple data consumers 438, 440, 442 have matching “profile” data, the profiler 428 delivers the common language messages 434 to all data consumers 438, 440, 442 with the matching “profile” data. For example, if a common language message 434 arrives with a LocationCode with a value of “5000”, then all data consuming applications 438, 440, 442 that have a LocationCode of “5000” will receive the common language message 434.

A CTI back office application 404, 406, 408 is a good example of a back office application 404, 406, 408 that implements an asynchronous communication model. In the example illustrated in FIG. 4, the back office application #1 (404) plays the role of the CTI back office application 404. The CTI back office application 404 generates messages 410, called events, containing information about the state of the telephony set for a company agent/employee. The event messages 410 from the back office application 404 are received by the BOA server 436 and are processed by the BOA server 436 in order to create common language messages 434 for use by the specific data consumer 442 with a “profile” matching the data in the event message 410. The following steps describe the process 450 associated with handling an unsolicited call ringing event message 410.
1. The CTI back office application (404) sends a call ringing event message (410).

2. The back office communication component (430) reads the event message (410) from the back office application (404) in the native format back office application (404) format and converts the event message (410) into an object message (432), and forwards the object message (432) to the protocol abstraction layer (426), where the object message is as shown below:

```
public class implements PALRules
{
    public int Category = 100;
    public int Function = 2;
    public String Extension=”77885”;
    public String Location=”5000”;
    public String CallingNumber=”303-555-1234”;
    public String CalledNumber=”1-800-555-HELP”;
    public int getCategoryCode( )
    {
        return Category;
    }
    public int getFunctionCode( )
    {
        return Function;
    }
    public String getObjectName( )
    {
        return “CallRinging”;
    }
    public void printObject( )
    {
        System.out.println(“Category:”+ Category);
        System.out.println(“Function:”+ Function);
        System.out.println(“Extension:”+ Extension);
        System.out.println(“Location:”+ Location);
        System.out.println(“Calling Number:”+ CallingNumber);
        System.out.println(“Called Number:”+ CalledNumber);
    }
}
```

If the BOA server (436), also known as the BOA back office integration protocol (436), invoked the printObject( ) method of the PALRules interface of the object message (432), the BOA server (436) will generate the following output:

Category: 100

Function: 2

Extension: 77885

Location: 5000

Calling Number: 303-555-1234

Called Number: 1-800-555-HELP

3. The protocol abstraction layer (426) using data from the object collection interface (424) and the OTCC converts the object message (432) into a common language message (434) and hands the common language message (434) over to the profiler (428). Note that the object collection interface (424) obtains the message structure and description information from non-volatile storage (416). The non-volatile storage (416) is configured with message data (414) obtained from the user through the administrative user interface (412). The administrative user interface (412) is also used to configure the data consumer (438), (440), (442) “profiles” as well as to send/receive AUI messages (420) to/from the BOA server 436. The profiler (428) reads the data consumer identification information (418) from the non-volatile storage (416). The common language message (434), in XML format, created by the protocol abstraction layer (426) is shown below:

```
<Message>
    <Category>100</Category>
    <Function>2</Function>
    <Body>
        <Extension>77885</ Extension>
        <Location>5000</Location>
        <CallingNumber>303-555-1234</CallingNumber>
        <CalledNumber>1-800-555-HELP </calledNumber>
    </Body>
</Message>
```

4. When the profiler (428) receives the common language message (434), the profiler (428) locates the specified data consumer by matching field values of the common language message (434) for fields such as “Extension”, “Location”, “Email-ID”, or “Main Frame ID” with field values of the data consumer “profiles.” Once a matching profile is found, the profiler (428) determines the login identifications of all matching data consumer “profiles.” For the example illustrated in FIG. 4, only one login identification is found, so the common language message (434) is only posted to the data consumer (442) identified by the profiler (428). In some instances, the back office identifying fields are kept or made blank by the BOA server (436). When all of the identifying fields are blank the profiler (428) will post the common language message (434) to all connected data consumers (438), (440), (442). A common language message (434) delivered to all data consumers (438), (440), (442) is called a broadcast message.

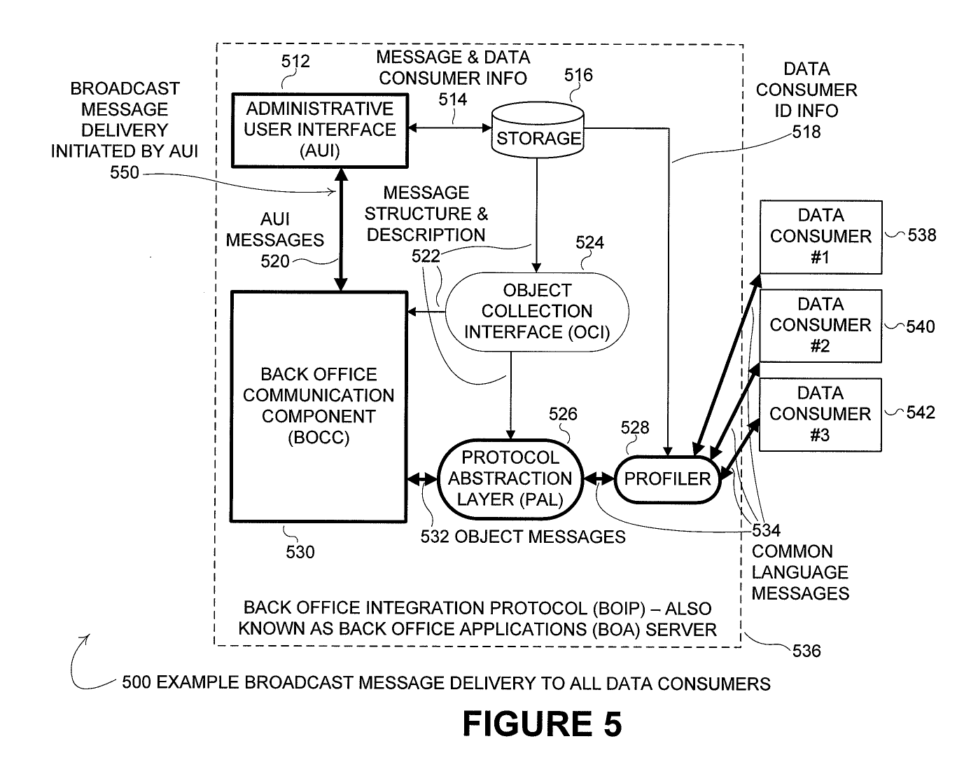

FIG. 5 is a schematic illustration 500 of the back office applications server 536 detailed system architecture showing an example of a broadcast message delivery 550 to all data consumers. Sometimes broadcast events are triggered by the back office system notifying the BOA server (536) of some major state change, such as on line to offline, offline to online, or to inform the data consumer 538, 540, 542 of the cause of some important data generation or update. The broadcast message may also be triggered by the administrative user interface 512 in order to convey a particular message to all data consumers 538, 540, 542. In the example illustrated in FIG. 5, the back office system needs to be shutdown for system maintenance. Before shutting the back office system down, the administrator may can post a message 550 to all data consumers 538, 540, 542 specifying the start and stop time of the system shutdown. While it is possible to broadcast a message to a subset of data consumers, the broadcast message 550 illustrated in FIG. 5 broadcasts to all data consumers 538, 540, 542. Further, the broadcast message 550 illustrated is generated by the administrative user interface 512. The following steps describe the communication processing of the broadcast message 550.
1. The administrative user interface (512) posts an unsolicited message to the back office communication component (530) specifying the scheduled system shutdown time.
2. The back office communication component (530) reads the AUI message (520), converts the AUI message (520) to an object message (532), and then sends the object message (532) to the protocol abstraction layer (528). The object message (532) is as shown below:

public class AUIBroadcastMessage implements PALRules

```
public class AUIBroadcastMessage implements PALRules
{
    public int Category = 200;
    public int Function = 2;
    public String SystemCode=”1000”;
    public String EventName=”Down Time”;
    public String FromTime=”10:00:00 AM 01/27/2005”;
    public String ToTime=”`12:00:00 PM 01/27/2005”;
public String TextMessage=”Main Frame System will be off for scheduled
Maintenance - Administrator”;
    public int getCategoryCode( )
    {
        return Category;
    }
    public int getFunctionCode( )
    {
        return Function;
    }
    public String getObjectName( )
    {
        return “CallRinging”;
    }
    public void printObject( )
    {
        System.out.println(“Category:”+ Category);
        System.out.println(“Function:”+ Function);
        System.out.println(“System Code:”+ SystemCode);
        System.out.println(“Event Name:”+ EventName);
        System.out.println(“From Time:”+ StartTime);
        System.out.println(“To Time:”+ EndTime);
        System.out.println(“Text Message:”+ TextMessage);
    }
}
```

If the BOA server (536), also known as BOA back office integration protocol, invoked the printObject( ) method of the PALRules interface of the object message (532), the BOA server (536) will generate the following output:

Category: 200

Function: 2

System Code: 1000

Event Name: Down Time

From Time: 10:00:00 AM 01/27/2005

To Time: 12:00:00 PM 01/27/2005

Text Message: Main Frame System will be off for scheduled Maintenance —Administrator

3. The protocol abstraction layer (526) using data from the object collection interface (524) and the OTCC converts the object message (532 ) into a common language message (534) and hands the common language message (534) over to the profiler (528). Note that the object collection interface (524) obtains the message structure and description information from non-volatile storage (516). The non-volatile storage (516) is configured with message data (514) obtained from the user through the administrative user interface (512). The administrative user interface (512) is also used to configure the data consumer (538), (540), (542) “profiles” as well as to send/receive AUI messages (520) to/from the BOA server (536). The profiler (528) reads the data consumer identification information (518) from the non-volatile storage (516). The structure of the common language message (534) is shown below:

```
<Message>
    <Category>200</Category>
    <Function>2</Function>
    <Body>
        <SystemCode></SystemCode>
        <EventName>Down Time</Event Name>
        <FromTime>10:00:00 AM 01/27/2005</FromTime>
        <ToTime>12:00:00 AM 01/27/2005</ToTime>
<TextMessage> Main Frame System will be off for scheduled
Maintenance - Administrator<TextMessage>
    </Body>
</Message>
```

4. When the profiler (528) receives the common language message (534), the profiler (534) scans for the names of attributes to identify the intended data consumer (538), (540), (542). For the present example no identifying fields are found which can be mapped to a particular data consumer “profile,” the profiler (528) posts the common language message (534) to all of the connected data consumers (538), (540), (542).

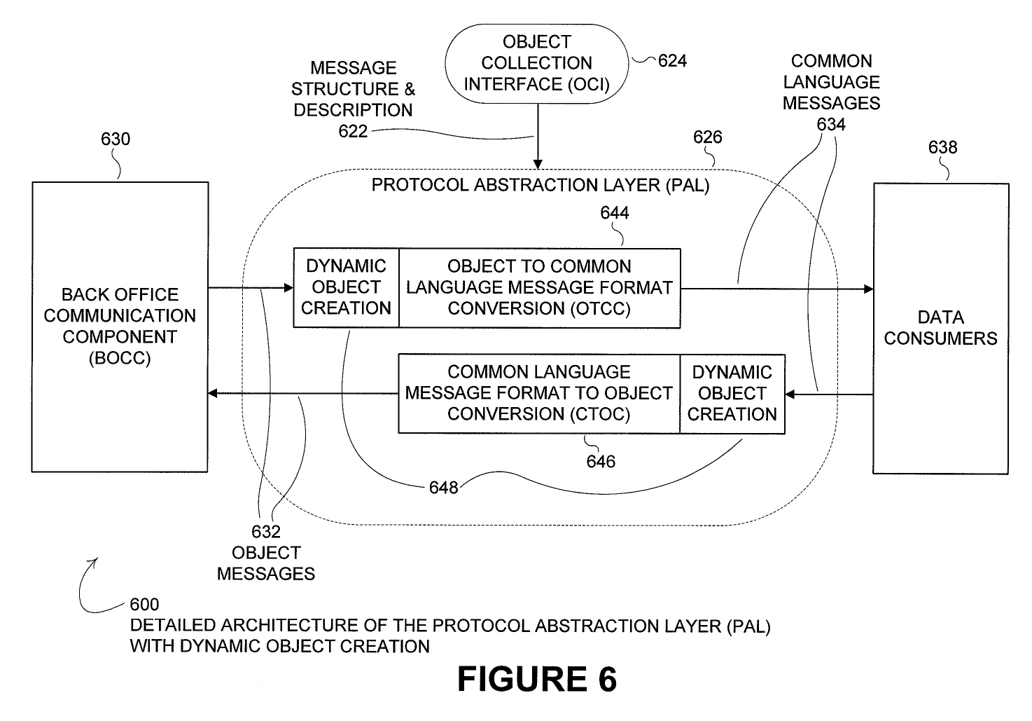

FIG. 6 is schematic illustration 600 of the detailed architecture of the protocol abstraction layer 626 with dynamic object creation 648. One of the prerequisites for protocol abstraction layer 626 without dynamic object creation 648 is that the OTCC 644 and the CTOC 646 modules must use objects should coded following the rules imposed by the protocol abstraction layer 626. Also, for the CTOC 646 conversion to operate successfully, each element name in the common language message 634 must match exactly with the associated element in the object message 632 in order to fill the value into the appropriate element of the object message 632. A protocol abstraction layer 626 without dynamic object creation 648 has the following disadvantages:

each object 632 must be coded and compiled error free;

the software programmer must make sure that all rules imposed by the protocol abstraction layer 626 are implemented in the object message 632;

if a new message 634 is added to the system, then the new object 632 must be coded, submitted, and registered in the system object collection interface 624;

if a field in a request/response message 634 is added or deleted, then the object 632 must go through the coding, compilation and deployment cycle again; and

a request object 632 requires one to one correspondence in common language message 634 element names with the object message 632 element names.

To eliminate the above specified disadvantages, an embodiment of the protocol abstraction layer may add the ability to create objects dynamically. To dynamically create an object from a request message 634, dynamic object creation 648 will make the new object by creating a base object and adding the common language message 634 data element tag names as object elements and the common language message 634 tags as the associated object element values. For a response message 632 from the back office space via the back office communication component 630, dynamic object creation 648 adds elements to the object similar to the elements provided by the back office application message.

For a protocol abstraction layer module 626 without dynamic object creation 648, a developer has to develop both request and response objects 632 for the OTCC 644 and the CTOC 646 processes to work properly. For a protocol abstraction layer module 626 with dynamic object creation 648, the object description is stored as configuration information in common language message format in storage. The message structure and description 622 in storage is accessed via the object collection interface 624. When an object description is not present in the object collection interface 624 for an incoming request message 634, the object message 632 will be created from the common language message 634 by taking all required information from the common language message format elements in the common language message 634. New objects 632 will be created as needed by the protocol abstraction layer 626.

The new object descriptor created by dynamic object creation 648 has two sections, a header and a descriptor. The header describes the unique, identifying elements of the new object including: category code, function code, and object name. The descriptor contains each new element descriptor along with element type, element value data type, element array attributes such as number of dimension, and other similar configuration parameters. The new object descriptor format is as follows:

```
  <Object>
    <Header>
      <Category><Category>
      <Function></Function>
      <Name></Name>
    </Header>
    <Descriptor>
      <Field Name=“FieldName”
Type=“{char,byte,boolean,int,float,double,long,String}”
      IsArray=“{true,false}” dimensions=“numeric value”/>
    </Descriptor>
  </Object>
```

The following is an example of a sample object descriptor.

```
  <Object>
    <Header>
      <Category>5000<Category>
      <Function>1</Function>
      <Name>DatabaseRequest</Name>
    </Header>
    <Descriptor>
      <Field Name=“TableName” Type=“String” IsArray=“false”
dimensions=“0”/>
      <Field Name=”Condition” Type=”String” IsArray=”false”
dimensions=”0”/>
    </Descriptor>
</Object>
```

When the protocol abstraction layer 626 receives a request message 634 from the data consumer 638, the request message 634 will have the following format, which corresponds to the object descriptor.

Sample Dynamic Object Creation Request Message

```
<Message>
  <Category>5000</Category>
  <Function>1</Function>
  <Body>
    <TableName>EmployeeDatabase</TableName>
    <Condition>age</Condition>
  </Body>
</Message>
```

When the protocol abstraction layer 626 receives the request message 634, the protocol abstraction layer 626 searches for the matching object descriptor and then generates the object dynamically as described in the following steps. Note that dynamic object creation 648 also implements the proper protocol abstraction layer rules.

```
Class EmployeeRequest implements PAL Rules
{
  public int Category = 5000;
  public int Function = 1;
  public String TableName =null;
  public String Condition = null;
  public int getCategoryCode( )
  {
    return Category;
  }
  public int getFunctionCode( )
  {
    return Function;
  }
  public String getObjectName( )
  {
    return “CustomerDetails”;
  }
  public void printObject( )
  {
    System.out.println(“Category:”+ Category);
    System.out.println(“Function:”+ Function);
    System.out.println(“TableName:”+ TableName);
    System.out.println(“Condition:”+ Condition);
  }
};
```

If the object descriptor is not found in the object collection interface 624, the output object will contain the common language message elements with a “string” data type, because there is no way from to determine what the back office system expect the data format to be based on the common language message request 634. The back office application can convert the “string” data type to any data type required. For both the OTCC 644 and the CTOC 646 processes, dynamic object creation 648 is the first step in the process.

Dynamic object creation 648 has many advantages compared to object configuration done by the administrative user interface, including:.

no object 632 must be created for a normal request and response;

objects are created from the common language message 634 itself;

the administrative user interface may be used to define the objects which are created dynamically at run time; and

when a back office message changes by adding or removing fields from a message, the system doesn't break down on the message processing as a new field or removed field will not be part of the dynamically created object, thus, “loosely coupling” the BOA server with the back office application.

The various embodiments make data consumer applications more data processing and presentation oriented by providing a single common communication format for data consumer applications to access back office or data source applications. An embodiment changes the communication model from multiple, proprietary, vendor specific communications to global, standard and common communications. An embodiment helps to implement a common communication protocol model by integrating the multiple communication technologies of multiple back office applications and providing single, simple, industry standard message exchange. The single, simple message exchange may be based on XML, providing a platform independent, text based, well defined, vendor independent data encoding format. With an embodiment, the data consumer application must implement only one communication model, the common language message format messaging model. Further, the data consumer application is abstracted by a common language protocol layer and, hence, will not be affected by any change in the back office communication model or an addition or change to the back office applications. With an embodiment, the data consumer application may be developed using a platform independent language and, thus, may be deployed on a variety of platforms. Additionally, the data consumer applications may choose and select the data elements as desired from the common language messages. Lastly, with an embodiment, the data consumer application may receive messages without the protocol formality of interacting directly with the back office applications.

The various embodiments therefore provide a single communication interface for communications between end user applications, such as an agent user interface, and back office applications, such as a database. The single communication interface precludes the need to create the numerous communication applications necessary for each different back office application and each different end user application. The creation of a communications interface for a back office or an end user application may take a significant amount of programming time and expense. The embodiments provide an abstraction layer between the end user application and the multiple communication technologies of multiple back office applications. The single communication interface of the embodiments reduce the need for multiple user interfaces using multiple technologies, thus reducing the complexity, maintenance, customer interaction time, and upgrade costs for a typical business environment. Further, an embodiment may be a platform independent, distributed, server deployed application.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for interfacing back office enterprise computer systems to end user computer systems comprising:
sending and receiving back office messages to and from at least one back office application, said back office messages formatted according to back office communication protocols, said back office communication protocols being a variety of communication protocols selected according to requirements of said at least one back office application;
sending and receiving common language messages to and from at least one data consumer application, said common language messages formatted according to a single common communication protocol;
converting said back office messages being delivered to said at least one data consumer application from said back office communication protocols into intermediate compiled object messages for data manipulation prior to finally converting said intermediate compiled object messages into said single common communication protocol for delivery as said common language messages, said intermediate compiled object messages being object data structures written in a standard computer software language and compiled in an associated computer software language compiler application; and
converting said common language messages being delivered to said at least one back office application from said single common communication protocol into said intermediate compiled object messages for data manipulation prior to finally converting said intermediate compiled object messages into said back office protocols for delivery as said back office messages.

2. The method of claim 1 further comprising supplying object structures and descriptions of said intermediate compiled data structures via an object collection interface.

3. The method of claim 2 wherein said single common language communication protocol follows standard extensible Markup Language (XML) specification rules of message construction and said object structures follow Plain Old Java Object (POJO) rules.

4. The method of claim 2 further comprising holding said object structures and descriptions contained in said object collection interface in non-volatile data storage.

5. method of claim 4 further comprising allowing an administrator to configure said object structures and descriptions held in said non-volatile data storage via an administrative user interface.

6. The method of claim 5 wherein said administrative user interface allows said administrator to send messages to said at least one back office application and said at least one data consumer application.

7. The method of claim 5 further comprising identifying said at least one data consumer application based on a data consumer profile using a profiler, said profiler only delivering said common language messages intended for said at least one data consumer application associated with said data consumer profile when identifying data contained in said common language messages matches identified data contained in said data consumer profile.

8. The method of claim 1 further comprising dynamically creating said intermediate compiled object messages at runtime without first compiling said intermediate compiled object messages.

9. A back office applications server for interfacing back office enterprise computer systems to end user computer systems comprising:
a communications portal that sends and receives back office messages to and from at least one back office application, said back office messages formatted according to back office communication protocols, said back office communication protocols being a variety of communication protocols selected according to requirements of said at least one back office application;
a communications portal that sends and receives common language messages to and from at least one data consumer application, said common language messages formatted according to a single common communication protocol;
a back office message processing subsystem that converts said back office messages being delivered to said at least one data consumer application from said back office communication protocols into said common language communication protocol for delivery as said common language messages;
a common language message processing subsystem that converts said common language messages being delivered to said at least one back office application from said single common communication protocol into said back office communication protocols for delivery as said back office messages;
a back office communication component that converts said back office messages into intermediate compiled object messages for data manipulation, said back office communication component also converts said intermediate compiled object messages into back office messages, said compiled object messages being object data structures written in a standard computer software language and compiled in an associated computer software language compiler application;
a protocol abstraction layer that converts said intermediate compiled object messages into said common language messages and converts said common language messages into said intermediate compiled object messages; and
an object message communication pathway between said back office communication component and said protocol abstraction layer that exchanges said intermediate compiled object messages between said back office communication component and said protocol abstraction layer.

10. The back office applications server of claim 9 further comprising an object collection interface that supplies object structures and descriptions of said intermediate compiled data structures to said back office communication component and said protocol abstraction layer.

11. The back office applications server of claim 9 wherein said single common language communication protocol follows standard eXtensible Markup Language (XML) specification rules of message construction.

12. The back office applications server of claim 10 wherein said object structures follow Plain Old Java Object (POJO) rules.

13. The back office applications server of claim 10 further comprising non-volatile data storage holding said object structures and descriptions contained in said object collection interface.

14. The back office applications server of claim 13 further comprising an administrative user interface that allows an administrator to configure said object structures and descriptions held in said non-volatile data storage.

15. The back office applications server of claim 14 wherein said administrative user interface allows said administrator to send messages to said at least one back office application and said at least one data consumer application.

16. The back office applications server of claim 14 further comprising a profiler that identifies said at least one data consumer application based on a data consumer profile, said profiler only delivers said common language messages intended for said at least one data consumer application associated with said data consumer profile when identifying data contained in said common language messages matches identified data contained in said data consumer profile.

17. The back office applications server of claim 10 wherein said protocol abstraction layer further comprises:
an object to common language message format conversion subsystem that converts said intermediate compiled object messages into said common language messages; and
a common language message format to object conversion subsystem that converts said common language messages into said intermediate compiled object messages.

18. The back office applications server of claim 17 wherein said protocol abstraction layer further comprises a dynamic object creation subsystem that permits said protocol abstraction layer to create said intermediate compiled object messages at runtime without compiling said intermediate compiled object messages, said dynamic object creation subsystem being part of said object to common language message format conversion subsystem and said dynamic object creation subsystem also being part of said common language message format to object conversion subsystem.

19. The business rules workflow system of claim 9 wherein said business rules workflow system is incorporated in a Computer Telephony Integration (CTI) system.

20. A back office applications server for interfacing back office enterprise computer systems to end user computer systems comprising:
means for sending and receiving back office messages to and from at least one back office application, said back office messages formatted according to back office communication protocols;
means for sending and receiving common language messages to and from at least one data consumer application, said common language messages formatted according to a single common communication protocol;
means for converting said back office messages being delivered to said at least one data consumer application from said back office communication protocols into said single common communication protocol for delivery as said common language messages; and
means for converting said common language messages being delivered to said at least one back office application from said single common communication protocol into said back office protocols for delivery as said back office messages.
